(19) United States
(12) Patent Application Publication
(10) Pub. No.: US 2019/0050898 A1
(43) Pub. Date: Feb. 14, 2019

(54) BAYESIAN APPROACH TO INCOME INFERENCE IN A COMMUNICATION NETWORK

(71) Applicant: Grandata, Inc., San Francisco, CA (US)

(72) Inventors: Carlos Sarraute, Buenos Aires (AR); Martin Minnoni, Buenos Aires (AR); Matias Travizano, San Francisco, CA (US); Jorge Brea, Buenos Aires (AR)

(73) Assignee: Grandata, Inc.

(21) Appl. No.: 16/101,317

(22) Filed: Aug. 10, 2018

Related U.S. Application Data
(60) Provisional application No. 62/544,602, filed on Aug. 11, 2017.

(51) Int. Cl. G06Q 30/02; G06N 7/00; G06F 17/30

(52) U.S. Cl. CPC G06Q 30/0255; G06N 7/005; G06F 17/30958; G06F 17/30991; G06F 17/30997; G06Q 30/0201

(57) ABSTRACT

Users can be classified as belonging to one of multiple income categories. A communications graph can be generated based on call data records (CDRs), the graph including a subset of nodes representing users of a mobile telephony network whose income is estimated based on available banking records. For a node representing a user whose income is unknown (i.e., a node that is not within the subset of nodes), and which is connected by a link to at least one node within the subset of the nodes, a Bayesian prediction algorithm may be used to classify the selected node. The Bayesian prediction algorithm may include defining a prior probability distribution of a Bayesian inference with a parameter based on a number of outgoing communication sessions from the selected node to nodes associated a particular income category, and computing a value for a lowest N^{th} percentile of the prior probability distribution.

### CROSS REFERENCE TO RELATED APPLICATION

This application claims priority to commonly assigned, U.S. Provisional Patent Application Ser. No. 62/544,602, filed Aug. 11, 2017. Application Ser. No. 62/544,602 is fully incorporated herein by reference.

### BACKGROUND

Recent years have seen an exponential growth in the capacity to gather, store, and manipulate massive amounts of data across a broad spectrum of disciplines. In astrophysics, our capacity to gather and analyze massive datasets from astronomical observations has significantly transformed our capacity to model the dynamics of the cosmos. In sociology, our capacity to track and study traits from individuals within a population of millions has allowed for the creation of social models at multiple scales, tracking individual and collective behavior, both in space and time, with a granularity not even imagined twenty years ago.

In particular, the explosion of mobile phone communications in recent years has provided a very rich view into the social interactions and the physical movements of large segments of a population, as exhibited in mobile phone datasets. For example, the voice calls and text messages exchanged between people, together with the call locations (recorded through cell tower usages), can be used with today's increased data processing resources to glean interesting insights about the users' social fabric, including particular social relationships and traits, as well as regular patterns of behavior both in space and time, such as their daily and weekly mobility patterns.

In addition, demographic factors play a role in the constitution and preservation of social relationships. For instance, with regards to age, individuals have a tendency to establish relationships with others of similar age. This phenomenon is called age homophily. Economic factors are also believed to have a determining role in both the social network's structure and dynamics. However, there are still very few large-scale quantitative analysis capabilities for understanding the interplay between economic status of individuals and their social network.

The disclosure made herein is presented with respect to these and other considerations.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 is a diagram illustrating an example technique for using call data records (CDRs) and banking records to generate a communications graph having income information for a subset of the graph's nodes, and using a Bayesian prediction algorithm to classify users of a mobile telephony network whose income is unknown as belonging to one of multiple income categories.

FIG. 2 illustrates a flowchart of an example process for using a Beta distribution to classify users of a mobile telephony network whose income is unknown as belonging to one of two income categories (e.g., low or high income).

FIG. 3 illustrates a flowchart of an example process for using a Dirichlet distribution to classify users of a mobile telephony network whose income is unknown as belonging to one of three or more income categories.

FIG. 4 illustrates a flowchart of an example process for classifying multiple users of a mobile telephony network as belonging to one of multiple income categories to generate inferred user income data, and processing the inferred user income data through a recommendation system to determine a targeted set of users for an acquisition campaign.

FIG. 5 illustrates a flowchart of an example process for generating a communications graph and augmenting the graph with income information, which can be used with Bayesian prediction to classify users of a mobile telephony network as belonging to one of multiple income categories.

FIG. 6 illustrates a Receiver Operating Characteristic (ROC) curve, showing TPR and FPR for the set of possible values of the threshold, τ.

FIG. 7 shows relationships between feature extraction methods of a machine learning approach to income inference.

FIG. 8 is a block diagram of an example architecture of a computing device(s) configured to implement the techniques described herein.

### DETAILED DESCRIPTION

Described herein are, among other things, techniques and systems for using call data records (CDRs) and banking records to generate a communications graph having income information for a subset of the graph's nodes, and using a Bayesian prediction algorithm with the communications graph to classify users of a mobile telephony network whose income is unknown as belonging to one of multiple income categories. The techniques and systems described herein leverage the socioeconomic homophily present in a mobile telephony network to generate inferences of the socioeconomic status (e.g., estimated income ranges/categories) of users whose income is unknown. In other words, the techniques and systems described herein infer income for users based on the communications that take place between the users and their contacts for which income information is available.

The ability to infer a user's income with greater accuracy, as compared to existing methods of income inference, allows for gaining a better understanding of the demographic features of a population. This improved understanding can be used in various downstream applications. For example, the classifications of users within one of multiple income categories (e.g., low income, high income, etc.) generates inferred user income data that can be processed through a recommendation system to determine a targeted set of users who can be contacted for an acquisition campaign (e.g., a credit card campaign). In this manner, an entity involved in an acquisition campaign is able to conserve valuable resources (e.g., time, money, etc.) by more efficiently targeting and selecting a set of users whose estimated income is in an appropriate income range for the acquisition campaign (e.g., users whose estimated income suggests they are a low credit risk). Thus, efficiencies are gained by employing the techniques and systems disclosed herein. In an illustrative example, a bank entity might receive a targeted set of users as recommendation system output based at least in part on the inferred user income data. The bank entity may use this recommendation system output for an acquisition campaign by contacting the targeted set of users via contact channels, which are also output by the recommendation system in association with the targeted set of users. This allows the bank entity to (i) attract new credit card clients that are of low credit risk, or otherwise increase the number of newly acquired clients (e.g., new credit card clients), (ii) decrease the cost of acquisition, (iii) optimize its campaigns to avoid saturating the market in a short period of time, and/or (iv) find quality prospects outside the radar of the bank entity's competition. With an income inference using the techniques and systems described herein, it is possible to target users that have a higher probability of being interested in an offer (e.g., a credit card offer). Given that targeted prospects are selected by non-standard banking and financial information (e.g., telco data, such as CDRs, and telco data-based inferences), a significant amount of the targeted prospects are also not targeted by the bank entity's competition. This also introduces opportunities for cross-channel campaigns. The audiences are created using not only socioeconomic and demographic inferences. They also implement different coordinated multichannel targeting strategies. The implementation of inferences for better targeting, plus cross-channel strategy, provides a higher conversion rate of an acquisition campaign.

In some embodiments, a process for classifying users as belonging to one of multiple income categories may include generating a communications graph that includes nodes and links connecting those nodes. A subset of the nodes represent users of a mobile telephony network whose income is estimated based on available banking records. A remaining subset of the nodes represent users of the mobile telephony network whose income is unknown. The links of the communications graph connect pairs of the nodes based on communication sessions involving the users of the mobile telephony network that have taken place, as indicated in an available set of call data records (CDRs). With this communications graph generated, a node may be selected that represents a user whose income is unknown, and which is connected by a link to at least one node within the subset of the nodes that have income information. In other words, the selected node is not within the subset of the nodes that have income information, and the selected node is connected to at least one node that is associated with an estimated income. For the selected node, a Bayesian prediction algorithm may be used to classify the selected node into one of multiple income categories. The Bayesian prediction algorithm may involve (i) computing a number of outgoing communication sessions from the selected node to nodes of the communications graph that are associated with estimated incomes within a particular income category among multiple income categories, (ii) defining a prior probability distribution of a Bayesian inference, the prior probability distribution usable to determine a probability of belonging to the particular income category, wherein the number of outgoing communication sessions is used for a parameter of the prior probability distribution, (iii) computing a value for a lowest N^{th} percentile of the prior probability distribution, and (iv) classifying the selected node as belonging to the particular income category based at least in part on the value for the lowest N^{th} percentile.

Using the disclosed Bayesian approach, users of a mobile telephony network whose income is unknown may be classified as belonging to one of multiple income categories based on the notion that income homophily exists within the communications graph. The income homophily indicates that the income of contacts with whom a user communicates can be used as an indicator of the income associated with that particular user. The Bayesian approach outperforms known alternative methods for predicting income of users of a communications network, and, hence, provides income inferences with improved accuracy.

Also disclosed herein are systems comprising one or more processors and one or more memories, as well as non-transitory computer-readable media storing computer-executable instructions that, when executed, by one or more processors perform various acts and/or processes disclosed herein.

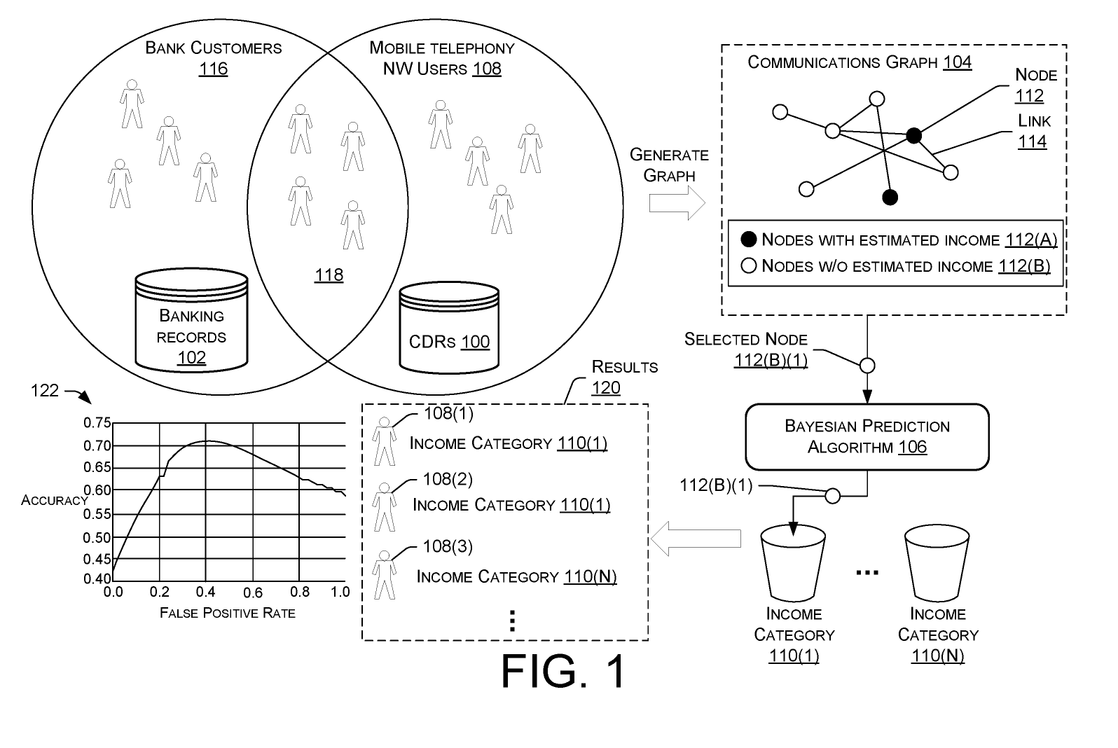

FIG. 1 is a diagram illustrating an example technique for using call data records (CDRs) 100 and banking records 102 to generate a communications graph 104 having income information for a subset of the graph's nodes, and using a Bayesian prediction algorithm 106 with the communications graph 104 in order to classify users 108 of a mobile telephony network whose income is unknown as belonging to one of multiple income categories 110(1) . . . 110(N) (collectively 110). It is to be appreciated that the elements shown in FIG. 1 are merely illustrative and are referenced for explanatory purposes. Furthermore, although example devices and systems to implement the disclosed techniques are described in more detail below, it is to be appreciated that the techniques described herein may be performed by a single computing device, or a combination of computing devices.

FIG. 1 illustrates two primary data sources that are utilized with a Bayesian prediction algorithm 106 to infer the income range of individual users whose income is unknown. These two primary data sources include (a) call data records (CDRs) 100 and (b) banking records 102. The CDRs 100 may be collected by an operator of a mobile telephony network (e.g., a carrier who provides mobile telephony services to users). The CDRs 100 may be collected using various network components, such as components of an evolved packet core (EPC), whenever communication sessions are established between at least one user 108 of the mobile telephony network and another user. These users may employ wireless communication devices (e.g., mobile phones) to establish communication sessions over the mobile telephony network (also referred to herein as a cellular network, a communications network, a wireless network, etc.). Because an operator of the mobile telephony network may provide various types of communication services, the CDRs 100 may include data pertaining to any suitable type of communication session, including, without limitation, voice communication sessions (e.g., calls), text message communication sessions (e.g., Short Message Service (SMS) text, Real-Time Text (RTT) communication sessions, etc.), video call communication sessions, and so on.

In an illustrative example, a set of P CDRs 100 may include, without limitation, data pertaining to voice calls and text messages involving at least one party (the caller, the callee, or both) who is/are a subscriber(s) to the operator's services. The users 108 of the mobile telephony network shown in FIG. 1 may represent such subscribers to the operator's services. The set of P CDRs 100 may also span a time period (e.g., a period of three months). Each CDR p∈P may contain, without limitation, the phone numbers of the caller and callee [symbol] pₒ, p_{d} [symbol] , which may be anonymized using a cryptographic hash function for privacy reasons, the starting time, pₜ, of the communication session, and, in the case of voice calls, the call duration, pₛ. The latitude and longitude of the antenna used for each call [symbol] p_{y}, pₓ [symbol] , may also be included for a subset of the data (a subset of the CDRs 100). It is to be appreciated that the CDRs 100 may represent records collected by one or more operators of a mobile telephony network. In a scenario where the CDRs 100 represent CDRs collected by a single operator (e.g., a single carrier, telephone company, or the like), communications between customers of that operator, as well as communications between the customers and other users, can be collected and maintained in the CDRs 100, but the CDRs 100 would inherently omit information about communications between users who are not customers of the operator that collects and/or provides the CDRs 100. In some embodiments, the CDRs 100 may contain additional information to that described above, such as information specifying the guaranteed bit rate (GBR) bandwidth that is reserved (or negotiated) for the voice communication session, a radio access technology (RAT) type value, and/or a Quality of Service Class Indicator (QCI) value, which is usable to discern a protocol (e.g., voice over long term evolution (VoLTE)) used for the communication session.

The CDRs 100 can be used to generate (or construct) a communications graph 104 (sometimes referred to herein as a “social graph” 104) that includes nodes 112, and links 114 connecting pairs of the nodes 112. The nodes 112 correspond to the users 108 of the mobile telephony network to whom the CDRs 110 pertain, and the links 114 are based on the communication sessions included in the CDRs 110. Thus, the links 114 indicate a social affinity between the respective pairs of nodes 112 that are connected by a given link 114. In an illustrative example, if N is defined as the number of users 108 of the mobile telephony network, and P_{N}⊆P is defined as the calls where (∀ₚ∈P_{N})pₒ∈N∧p_{d}∈N, a communications graph G_{N} (104) can be generated. This graph 104 may contain nodes 112 that represent the users 108 of the mobile telephony network, as well as links 114 that represent the communication sessions (e.g., calls, text messages, etc.) exchanged between the users 108 and other users.

As mentioned, FIG. 1 also depicts another primary data source; namely, banking records 102. The banking records 102 may represent account balances of bank customers 116 of one or more banks. Like the CDRs 100, the bank records 102 may span a time period (e.g., a period of six months). In an illustrative example, a set of B banking records 102 may include, without limitation, data pertaining to the account balances of the bank customers 116 over a period of time. Each record for a bank customer b∈B may also include, without limitation, the phone number bₚ of the bank customer b, anonymized with the same hash function used in the set of P CDRs 100, as well as the reported income of the bank customer b over the time period (e.g., 6 months) (e.g., bₛ₀, . . . , bₛ₅). These values of reported income that span a time period may be averaged to obtain an average income bₛ, or an estimate of the bank customer's 116 income, for the given time period. The banking records 102 may further include, without limitation, demographic information for a subset of the bank customers 116 A⊆B. For example, the banking record 102 for each bank customer 116 u∈A may include the age uₐ of the bank customer 116, which allows for observing the differences in the income distribution according to the age of the bank customers 116. Homophily with respect to age has been observed and used to generate inferences. It has also been observed that median income increases with age, in general, up to a certain point (e.g., a retirement age range, such as 60-65 years) in some populations, and then the median income rapidly decreases with age beyond that point.

As shown in the Venn diagram of FIG. 1, there is a subset of users 118 who are both bank customers 116 and users 108 of the mobile telephony network. This allows a computing device(s) to match the CDRs 100 with the banking records 102 so that the communications graph 104 can be augmented with income information that is derived from the banking records 102. For example, because the phone numbers in each CDR 100 (e.g., each call pₒ and p_{d}) are anonymized with the same hash function used to anonymize the phone numbers in the banking records 102, bₚ, the CDRs 100 can be matched with the banking records 102 to create an augmented communications graph 104 shown in FIG. 1:

G=P [symbol] _{p0=bp}B [symbol] _{pd=bp}B

Here, [symbol] denotes an inner join operator. Thus, G, which represents an augmented communications graph 104, includes income information (e.g., estimated incomes) for a subset of the nodes 112(A) in the communications graph 104. This subset of nodes 112(A) (e.g., the black-colored nodes in FIG. 1) represent the subset of users 118 who are both bank customers 116 and users 108 of the mobile telephony network. Thus, for ∀_{g}∈G, the available data may include the bank customer's 116 phone number gₚ, his/her average income over a time period (e.g., six months) gₛ, and his/her age gₐ. It is to be appreciated that, depending on the population in question, the communications graph 104 shown in FIG. 1 may include as many as a few million nodes 112 (e.g., about 2 million) with an even greater number of links 114 (E.g., about 5 million), which may represent several million communication sessions (e.g., about 30 million calls, about 5 million text messages). Of course, these numbers will vary depending on the population and the operator(s) of the mobile telephony network in question.

FIG. 1 illustrates the communications graph 104 that is augmented with income information. Accordingly, and as mentioned above, the subset of nodes 112(A) (e.g., the black-colored nodes in FIG. 1) represent users 108 of the mobile telephony network whose income is estimated based on available banking records (i.e., the users 118 who are both bank customers 116 and users 108 of the mobile telephony network). Meanwhile, a remaining subset of nodes 112(B) (e.g., the white-colored nodes in FIG. 1) represent users 108 of the mobile telephony network whose income is unknown (i.e., users 108 who are not in the subset 118). It is these users—those associated with the subset of nodes 112(B)—whose income is to be estimated using a Bayesian prediction algorithm 106.

The Bayesian prediction algorithm 106 is used to estimate the income for individual ones of the nodes that are in the subset of nodes 112(B), and which are connected by a link 114 to a node that is within the subset of nodes 112(A), which have income information associated therewith. It is noted that the nodes within the subset of nodes 112(B) are not within the subset of nodes 112(A) because the subsets 112(A) and 112(B) are mutually exclusive. The Bayesian prediction algorithm 106 leverages the income homophily that is present within the CDRs 100 of the mobile telephony network, and, hence, within the communications graph 104. In this manner, the income of users 108 whose income is unknown, but who have bank customers 116 in their neighborhood within the communications graph 104, can be estimated from the incomes of those neighboring bank customers 116. An evidentiary basis demonstrating income homophily will now be discussed.

For each pair [symbol] o, d [symbol] ∈G, X is defined as the set of incomes for callers and Y is defined as the set of incomes for callees. According to some observations of income homophily, X and Y can be shown to be significantly correlated. Given the broad non-Gaussian distribution of the income's values, a rank-based measure of correlation can be used, which is robust to outliers. Namely, the Spearman's rank correlation can be computed to test the statistical dependence of sets X and Y as follows:

$${r}_{s} = {p}_{rank ( X ) rank ( Y )} = \frac{cov ( rank ( x ) , rank ( y ) )}{{σ}_{rank ( X )} {σ}_{rank ( Y )}}$$

With observed data, this coefficient has been computed as rₛ=0.474. This result was compared to a randomized null hypothesis, where links between users are selected randomly disregarding income data, obtaining a p-value of p<10⁻⁶. These values for rₛ and p show a strong indication of income homophily among users in the communications graph 104. The techniques and systems disclosed herein leverage this income homophily to propagate income information to the subset of nodes 112(B) in the communications graph 104, which represent users 108 whose income is unknown. An example Bayesian prediction algorithm 106 will now be discussed.

Instead of predicting the exact value of a user's income, FIG. 1 shows a technique that distinguishes between multiple income categories 110(1) . . . 110(N). These multiple income categories 110 (income ranges) can be any number of two or more income categories 110. In some embodiments, two income categories (N=2) may be defined, such as a low income category 110(1) and a high income category 110(2). In an example that used data from a population in Mexico whose reported income is in Mexican pesos, a low income category 110(1) may be defined as R₁=[1000,6300), while a high income category 110(2) may be defined as R₂=[6300,∞). This allows for classifying users 108 whose income is unknown as belonging to either a low income category 110(1) or a high income category 112(2), which can be defined as the groups H₁, H₂⊆G, depending on gₛ, the users' income:

g∈Hᵢ⇔gₛ∈Rᵢ

The set Q can be defined as the group of users 108 having at least one connection link 114 to a bank customer 116 within the communications graph 104. For each user q^{j}∈Q, the number of outgoing calls aᵢ^{j} to the income category Hᵢ may be computed. Given the observed income homophily, if a user q^{j} has a higher number of calls aᵢ^{j} to the income category Hᵢ than the other income category, that user is more likely to belong to the income category Hᵢ than the other income category. In other words, a person is usually in the same income category as the majority of people the user calls.

While a straight forward approach might be to define the income category of a user as the category where most of the user's contacts belong, such an approach does not factor in the higher uncertainty in the estimates for users with fewer calls. To address this uncertainty, instead of using calling frequencies to define the probability of a user belonging to the high income category 110(2), the techniques and systems described herein use the amount of calls aᵢ^{j} (e.g., outgoing communication sessions) as parameters defining a Beta distribution for the probability of belonging to a given income category 110. Accordingly, the Bayesian prediction algorithm 106 (as its name implies) takes a Bayesian approach, rather than a frequentist approach, to income prediction, so that individual nodes in the subset of nodes 112(B) can be classified into one of the multiple income categories 110.

In the Bayesian prediction algorithm 106, B^{j} can be defined as the Beta probability distribution function for each user:

$${B}^{j} ( x ; {α}^{j} , {β}^{j} ) = \frac{1}{B ( {α}^{j} {β}^{j} )} {x}^{{α}^{j} - 1} \cdot {( 1 - x )}^{{β}^{j} - 1}$$

Here, α^{j}=a₁^{j}+1 and β^{j}=a₂^{j}+1 are the parameters of the Beta distribution, and B is the Beta function, defined as:

$$B ( α , β ) = \frac{Γ ( α ) \cdot Γ ( β )}{Γ ( α + β )}$$

The above equation defines a distinct distribution (prior probability distribution) for each user. Having obtained the Beta distribution for the probability of belonging to the high income category 110(2), a value for a lowest N^{th} (e.g., lowest fifth) percentile (referred to herein as “p_{lower}”) can be computed for this probability distribution. If p_{lower} is greater than a threshold, τ, the selected node 112(B)(1)—which represents a user 108 whose income is unknown—can be classified as belonging to the high income category 110(2), H₂. Otherwise, if p_{lower} is equal to, or less than, the threshold, τ, the selected node 112(B)(1) can be classified as belonging to the low income category 110(1), H₁. This criterion takes into account both the mean and the broadness (uncertainty) of the distribution. Furthermore, the income category 110 in which the selected node 112(B)(1) (i.e., user) is classified depends not only on its Beta distribution, but also on the choice of the threshold, τ. Although the value of the threshold, τ, depends on the population in question, a suitable value in at least one example population that was studied is a threshold value of τ=0.4. In some embodiments, this threshold, τ, may be set to a value that maximizes the accuracy of the classification, where the accuracy is a function of the False Positive Rate (FPR). For example, as shown by the graph 122 in FIG. 1, the performance of the Bayesian prediction algorithm 106 can be evaluated by computing its accuracy for different values for the threshold, τ, and this can be plotted on a curve, as shown by the graph 122. As exhibited in the example graph 122 of FIG. 1, the best accuracy obtained is 0.71 for τ=0.4. Thus, the threshold, τ, can be set to a value (or the value for the threshold, τ, can be selected) based on a maximum of the accuracy curve, the accuracy being a function of the FPR.

The above example classifies nodes 112(B) into one of two income categories 110(1) or 110(2). If more than two income categories (N≥3) are defined, a Dirichlet distribution can be utilized in the Bayesian prediction algorithm 106 to classify nodes (users) into one of the multiple income categories 110. In an illustrative example, the multiple income categories 110(1) . . . 110(N) may be defined as five (N=5) different income categories H₁, . . . , H₅⊆G of increasing wealth. In this example, a user may be part of an income category if his/her income is between the defined bounds, that is, g∈Hᵢ⇔gₛ∈Rᵢ. For an illustrative example of a population in Mexico with a currency in Mexican pesos, the income ranges may be set as follows R₁=[1000, 2500); R₂=[2500, 7500); R₃=[7500, 20000); R₄=[20000, 50000); R₅=[50000, ∞).

A set Q of users can be defined as a group of users 108 of the mobile telephony network whose income is unknown, and whose nodes 112(B) have at least one connection link 114 to a bank customer 116 (nodes 112(A)) in the communications graph 104. For each user q^{j}∈Q, the number of outgoing calls aᵢ^{j} to the income category Hᵢ may be computed. The amount of calls aᵢ^{j} can be used as parameters defining a Dirichlet distribution for the probability of belonging to each income category 110 of the three or more income categories 110. The Dirichlet probability distribution function D^{j} can be defined as follows:

$${D}^{j} ( {x}_{1} , … , {x}_{5} ; {α}_{1}^{j} , … , {α}_{5}^{j} ) = \frac{1}{B ( α )} {\prod }_{i = 1}^{5} {x}_{i}^{{α}_{i}^{j} - 1}$$

Here, αᵢ^{j}=aᵢ^{j}+1 are the parameters of the Dirichlet distribution, and B is the multivariate beta distribution function, defined by:

$$B ( {α}_{1} , … , {α}_{k} ) = \frac{{\prod }_{i = 1}^{k} Γ ( {α}_{i} )}{Γ ( {\sum }_{i = 1}^{k} {α}_{i} )}$$

The above equation defines a distinct Dirichlet distribution (prior probability distribution) for each user. For each of these distributions, marginal probability functions can be computed across the three or more income categories 110, which results in Beta distributed functions, and these can be used to obtain values for the lowest N^{th} (e.g., lowest fifth) percentile (p_{lower}ⁱ) in each income case i=1, . . . , 5. These multiple p_{lower} values can be compared to classify the selected node 112(B)(1)—which corresponds to a user 108 of unknown income—as belonging to one of the multiple income categories 110. For example, the income category 110 that is associated with the highest p_{lower} value may be selected as the income category 110 in which the node 112(B)(1) (or user) is classified.

In order to gain an intuition on how the classification extends to the three or more income categories 110 scenario, a binary classifier was constructed for each income category i by using the computed p_{lower}ⁱ value and a given threshold, τ. In each case, the threshold, τ, can be swept and the resulting Receiver Operating Characteristic (ROC) curve can be computed. This was done with experimentation on data for a population of users of a Mexican telecommunications operator, and the performance for the different income categories 110 was observed as follows: Area Under Curve (AUC₁)=0.68, AUC₂=0.69, AUC₃=0.63, AUC₄=0.68, AUC₅=0.69. In all cases, the Bayesian prediction algorithm 106 performed better than the random case, as will be described in more detail below.

As further illustrated in FIG. 1, results 120 may be generated that specify a set of users 108 of the mobile telephony network (whose income was previously unknown) and the incomes categories 110 in which those users 108 have been classified using the Bayesian prediction algorithm 106 described herein. In other words, because the nodes 112 in the communications graph 104 represent users 108 of the mobile telephony network, the techniques described herein for classifying nodes 112 can be translated into classifications of users into one of multiple income categories 110.

These results 120 (e.g., user income data) can be used for various downstream applications, such as outputting a recommendation of a targeted set (or subset) of the users 108 for an acquisition campaign based at least in part on the classifications of those users 108 into one of multiple income categories 110. For instance, a bank entity that is launching an acquisition campaign may wish to target users with low credit risk (e.g., users with income in one or more particular income ranges). Accordingly, the techniques and systems described herein may provide such a bank entity with insights into the estimated income of users by providing a targeted set of users in a particular income category 110 as recommended users to target in an acquisition campaign. It is to be appreciated that other downstream applications may benefit in similar ways from the improved accuracy of income inference that is provided by the techniques and systems described herein.

The processes described in this disclosure may be implemented by the architectures described herein, or by other architectures. These processes are illustrated as a collection of blocks in a logical flow graph. Some of the blocks represent operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order or in parallel to implement the processes. It is understood that the following processes may be implemented on other architectures as well.

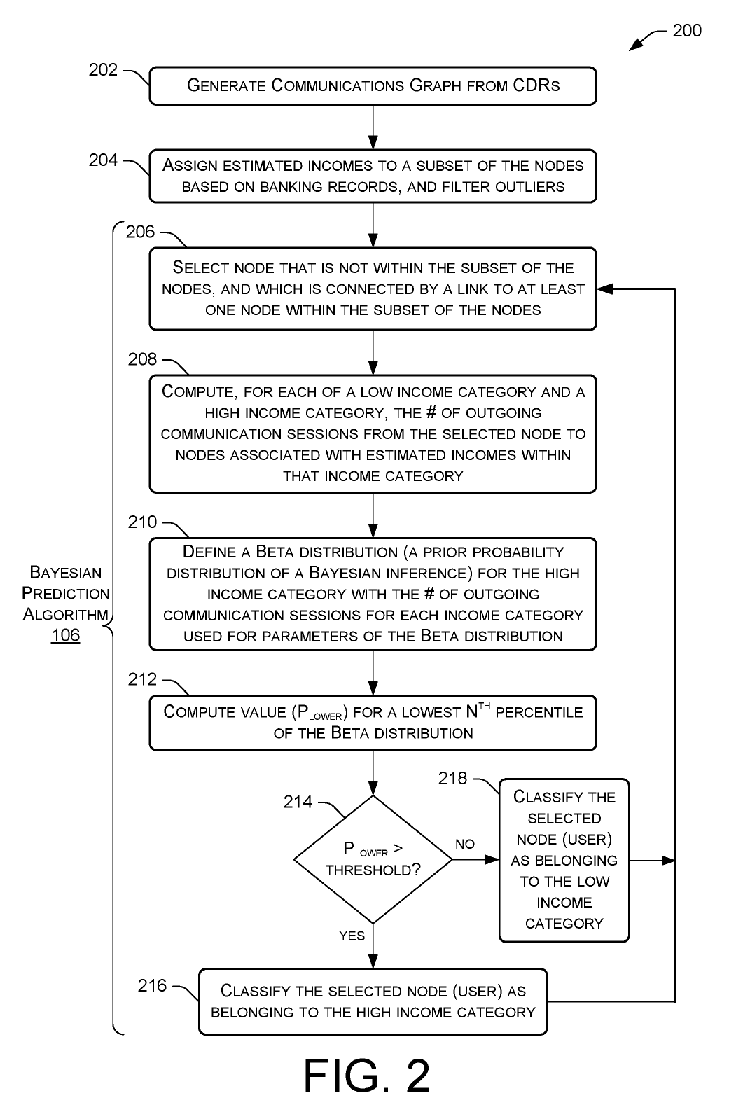

FIG. 2 illustrates a flowchart of an example process 200 for using a Beta distribution to classify users of a mobile telephony network whose income is unknown as belonging to one of two income categories (e.g., low or high income). For discussion purposes, the process 200 is described with reference to the previous figure.

At 202, a communications graph 104 may be generated based at least in part on CDRs 100 that contain information associated with communication sessions established over a mobile telephony network. The communications graph 104 generated at block 202 may include nodes 112 corresponding to users 108 of the mobile telephony network, and links 114 connecting pairs of the nodes 112 based on the communication sessions, as indicated in the available CDRs 100.

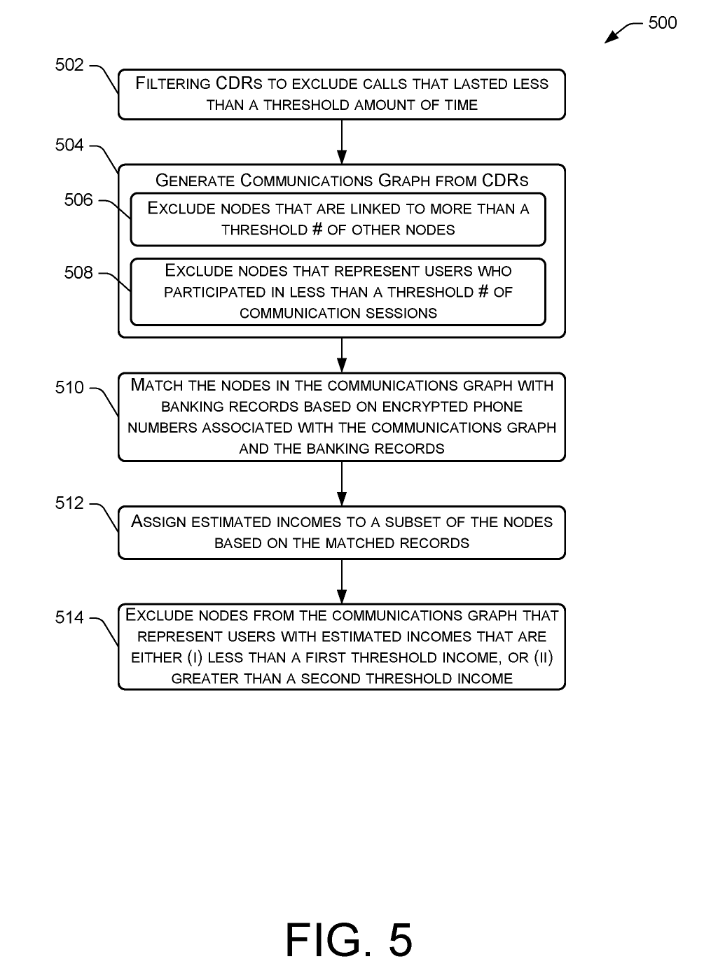

At 204, estimated incomes may be assigned to a subset of the nodes 112(A) of the communications graph 114 based at least in part on banking records 102 that contain information associated with account balances of bank customers 116, and outliers may be filtered from the data set. The subset of the nodes 112(A) with estimated incomes assigned thereto at block 204 may represent a subset 118 of the users 108 of the mobile telephony network who are also the bank customers 116. This results in a communications graph 104 that includes a subset of nodes 112(A) representing users 108 of a mobile telephony network whose income is estimated based on available banking records 102. The filtering of outliers at block 204 may include operations that are described in more detail below with respect to FIG. 5. For example, outlier nodes—such as nodes 112 that are associated with estimated incomes that are at least one of (i) less than a first threshold income or (ii) greater than a second threshold income—may be excluded from the communications graph 104 at block 204, resulting in the subset of nodes 112(A) with estimated income assigned thereto.

At 206, a node of the communications graph 104 may be selected. This selected node is one that is not within the subset of the nodes 112(A), but is instead within a remaining subset of nodes 112(B) representing users with unknown incomes. The selected node is also connected by a link 114 to at least one node within the subset of the nodes 112(A) that have income information.

At 208, a number may be computed for each income category of multiple income categories 110; namely, the number of outgoing communication sessions from the selected node to nodes of the communications graph 104 that are associated with estimated incomes within that particular income category 110.

At 210, a prior probability distribution of a Bayesian inference can be defined. This prior probability distribution is usable to determine a probability of belonging to a particular income category, and the numbers of outgoing communication sessions computed at block 208 may be used for parameters of the prior probability distribution. In this case, the prior probability distribution defined at block 210 comprises a Beta distribution, and the multiple income categories 110 comprise two income categories (e.g., a high income category and a low income category).

At 212, a value for a lowest N^{th} percentile (e.g., a lowest fifth percentile) of the prior probability distribution may be computed. This value is referred to herein as p_{lower}.

At 214, a determination may be made as to whether the value for the lowest N^{th} percentile (p_{lower}) computed at block 212 is greater than a threshold value, τ. If the value of the lowest N^{th} percentile (p_{lower}) is greater than the threshold value, τ, the process 200 may follow the “YES” route from block 214 to block 216.

At 216, the selected node may be classified as belonging to the particular income category 110 based at least in part on the value (p_{lower}) being greater than the threshold value, τ. If, at block 214, the value of the lowest N^{th} percentile (p_{lower}) is equal to, or less than, the threshold value, τ, the process 200 may follow the “NO” route from block 214 to block 218, where the selected node may be classified as belonging to the other income category 110 of the two income categories based at least in part on the value (p_{lower}) being equal to, or less than, the threshold value, τ.

The process 200 may iterate the Bayesian prediction algorithm 106 for each node in the subset of nodes 112(B) that do not have any estimated income assigned to them within the communications graph 104. That is, an additional node may be selected at block 206, which represents a user 108 whose income is unknown, and blocks 208-214 may be performed for that additional selected node in order to classify the additional selected node at blocks 216 or 218 as belonging to one of the two income categories 110. It is to be appreciated that the process 200 may iterate in this fashion for multiple additional nodes in the communications graph 104 that belong to the subset of nodes 112(B).

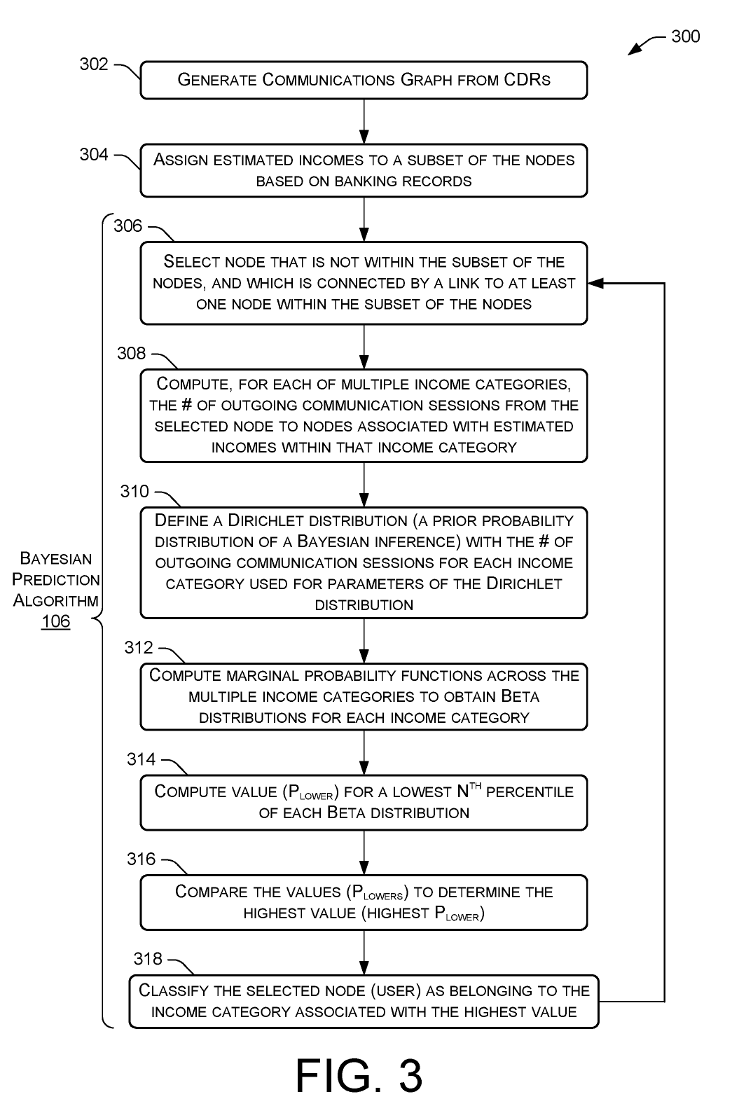

FIG. 3 illustrates a flowchart of an example process 300 for using a Dirichlet distribution to classify users of a mobile telephony network whose income is unknown as belonging to one of three or more income categories. For discussion purposes, the process 300 is described with reference to the previous figures.

At 302, a communications graph 104 may be generated based at least in part on CDRs 100 that contain information associated with communication sessions established over a mobile telephony network. The communications graph 104 generated at block 302 may include nodes 112 corresponding to users 108 of the mobile telephony network, and links 114 connecting pairs of the nodes 112 based on the communication sessions, as indicated in the available CDRs 100.

At 304, estimated incomes may be assigned to a subset of the nodes 112(A) of the communications graph 114 based at least in part on banking records 102 that contain information associated with account balances of bank customers 116. The subset of the nodes 112(A) with estimated incomes assigned thereto at block 304 may represent a subset 118 of the users 108 of the mobile telephony network who are also the bank customers 116. This results in a communications graph 104 that includes a subset of nodes 112(A) representing users 108 of a mobile telephony network whose income is estimated based on available banking records 102.

At 306, a node of the communications graph 104 may be selected. This selected node is one that is not within the subset of the nodes 112(A), but is instead within a remaining subset of nodes 112(B) representing users with unknown incomes. The selected node is also connected by a link 114 to at least one node within the subset of the nodes 112(A) that have income information.

At 308, a number may be computed for each income category of multiple income categories 110; namely, the number of outgoing communication sessions from the selected node to nodes of the communications graph 104 that are associated with estimated incomes within that particular income category 110.

At 310, a prior probability distribution of a Bayesian inference can be defined. This prior probability distribution is usable to determine a probability of belonging to a particular income category, and the numbers of outgoing communication sessions computed at block 308 may be used for parameters of the prior probability distribution. In this case, the prior probability distribution defined at block 310 comprises a Dirichlet distribution, and the multiple income categories 110 comprise more than two income categories (e.g., three, four, five, or more income categories).

At 312, marginal probability functions may be computed across the multiple income categories 110 to obtain a Beta distribution for each income category of the multiple income categories 110.

At 314, a value for a lowest N^{th} percentile (e.g., a lowest fifth percentile) of each Beta distribution may be computed to obtain multiple values for the lowest N^{th} percentile (multiple p_{lower} values).

At 316, the multiple values for the lowest N^{th} percentile (multiple p_{lower} values) may be compared to determine a highest value (a highest p_{lower} value) among the multiple values (multiple p_{lower} values).

At 318, the selected node may be classified as belonging to a particular income category that is associated with the highest value (a highest p_{lower} value) among the multiple values (multiple p_{lower} values).

The process 300 may iterate the Bayesian prediction algorithm 106 for each node in the subset of nodes 112(B) that do not have any estimated income assigned to them within the communications graph 104. That is, an additional node may be selected at block 306, which represents a user 108 whose income is unknown, and blocks 308-318 may be performed for that additional selected node in order to classify the additional selected node as belonging to one of the multiple income categories 110. It is to be appreciated that the process 300 may iterate in this fashion for multiple additional nodes in the communications graph 104 that belong to the subset of nodes 112(B).

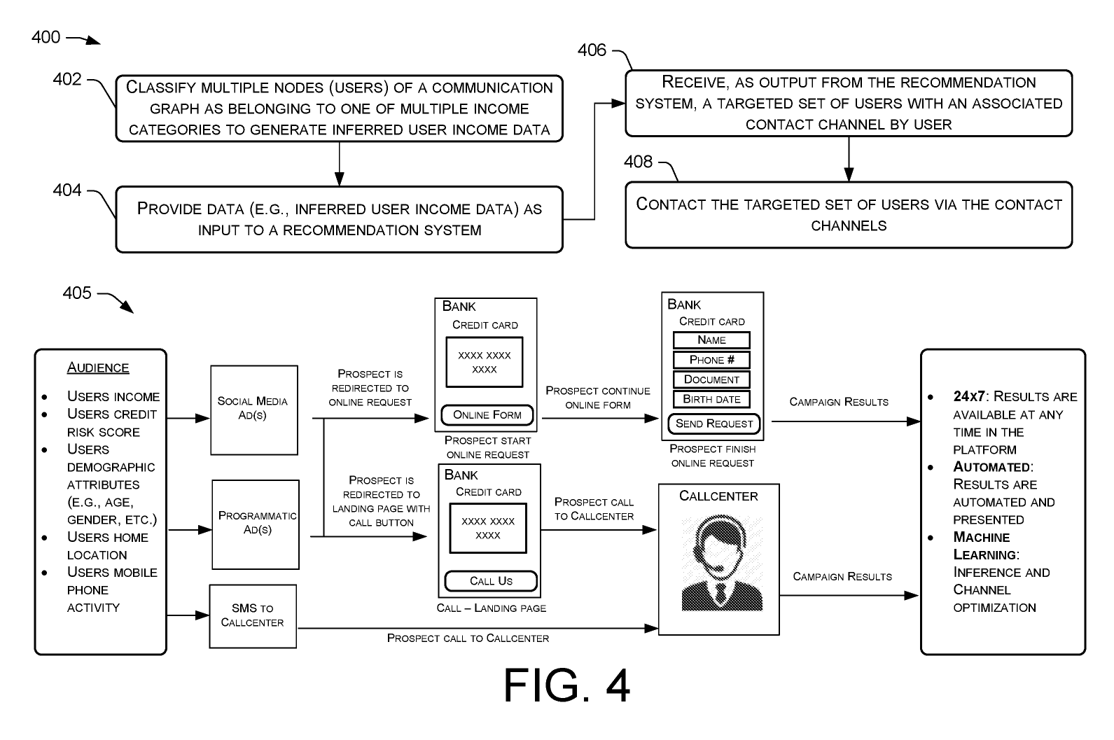

FIG. 4 illustrates a flowchart of an example process 400 for classifying multiple users of a mobile telephony network as belonging to one of multiple income categories to generate inferred user income data, and processing the inferred user income data through a recommendation system to determine a targeted set of users for an acquisition campaign. For discussion purposes, the process 400 is described with reference to the previous figures.

At 402, multiple nodes 112 of a communications graph 104 may be classified as belonging to one of the multiple income categories 110 using a prior probability distribution of a Bayesian inference to generate inferred user income data (e.g., the results 120, introduced in FIG. 1). For example, the process 200 and/or the process 300 may be iteratively performed to classify selected nodes—from a subset of nodes 112(B) within the communications graph 104 that represent users 108 of the mobile telephony network whose income is unknown—as belonging to one of multiple income categories 110.

At 404, the inferred user income data generated at block 402, among other types of data, can be provided as input to a recommendation system. As shown in the pictorial diagram 405 at the bottom of FIG. 4, other types of data may be input to the recommendation system at block 404, such as, without limitation, user income data obtained from a ground truth source (e.g., user income obtained directly from the banking records 102), data regarding users credit risk scores (inferred or provided by a ground truth source), demographic data regarding users demographic attributes (e.g., age, gender, etc.) (inferred or provided by a ground truth source), location data regarding users home location (inferred or provided by a ground truth source), and/or mobile data regarding users mobile phone activity (e.g., voice calls, SMS and data traffic, etc.). At 406, recommendation system output based on the input data may be received. The recommendation system output may include a targeted set of users and associated contact channels per user. As shown by the pictorial diagram 405, the contact channels associated with the targeted set of users may include, without limitation, social media advertisements (ads), programmatic ads, and/or text messages (e.g., SMS text messages, email, etc.).

At 408, the output received at block 406 may be utilized to contact users in the targeted set of users via the associated contact channels as part of an acquisition campaign. For example, as shown in the pictorial diagram 405, a social media ad(s) and/or a programmatic ad(s) may direct a user among the targeted set of users to navigate to a landing page via a mobile device that receives the ad, and/or a text message may invite a user among the targeted set of users to contact a call center. These features can be implemented in any suitable manner via one or more computing devices, such as by displaying a user interface on a mobile device of a user that directs a user to an online form to apply for a credit card, and/or that directs the user to a landing page with a call button, as shown in the pictorial diagram 405 of FIG. 4. When users interact with such a system, results of the acquisition campaign can be collected and analyzed for determining conversion rates, response rates to each contact channel, approval rates of prospects that respond to the campaign, coordinating multichannel targeting strategies, and/or optimizing targeting techniques through channel optimization (e.g., using machine learning techniques).

In an illustrative example, a bank entity might receive the targeted set of users as recommendation system output at block 406, and may use this recommendation system output for an acquisition campaign by contacting the targeted set of users at block 408. This allows the bank entity to (i) attract new credit card clients that are of low credit risk, or otherwise increase the number of newly acquired clients (e.g., new credit card clients), (ii) decrease the cost of acquisition, (iii) optimize its campaigns to avoid saturating the market in a short period of time, and/or (iv) find quality prospects outside the radar of the bank entity's competition. This is also more efficient for the bank entity because it does not waste resources (time and money) pursuing users in an income category that suggests they are of high credit risk. With an income inference using the techniques and systems described herein, it is possible to target users that have a higher probability of being interested in an offer (e.g., a credit card offer). Given that targeted prospects are selected by non-standard banking and financial information (e.g., telco data, such as CDRs 100, and telco data-based inferences), a significant amount of the targeted prospects are also not targeted by the bank entity's competition. This also introduces opportunities for cross-channel campaigns. The audiences are created using not only socioeconomic and demographic inferences. They also implement different coordinated multichannel targeting strategies. The implementation of inferences for better targeting, plus cross-channel strategy, provides a higher conversion rate of an acquisition campaign. This is just an example of a particular useful application of the techniques and systems disclosed herein, and are undoubtedly other downstream applications that can utilize the classifications of users into one of multiple income categories 110.

FIG. 5 illustrates a flowchart of an example process 500 for generating a communications graph and augmenting the graph with income information, which can be used with Bayesian prediction to classify users of a mobile telephony network as belonging to one of multiple income categories. For discussion purposes, the process 500 is described with reference to the previous figures.

At 502, prior to generating the communications graph 104 of FIG. 1, and with access to the CDRs 100, a computing device(s) may filter the CDRs 100 to exclude a subset of the CDRs that correspond to calls that lasted less than a threshold amount of time. The threshold amount of time can be any suitable value. In an illustrative example, calls that last less than five seconds may be filtered out from the data set. This is because calls of such a short duration can be considered to be misdials or the like, which do not represent real conversations between users.

At 504, a communications graph 104 may be generated based at least in part on CDRs 100, after filtering out the calls that lasted less than the threshold amount of time. The communications graph 104 generated at block 502 may include nodes 112 corresponding to users 108 of the mobile telephony network, and links 114 connecting pairs of the nodes 112 based on the communication sessions, as indicated in the CDRs 100 after the filtering. The sub-blocks of block 504 describe example outlier filtering steps that can be taken to ensure that the dataset of the communications graph 104 includes useful information and/or information pertaining to human users.

At 506, the computing device(s) may exclude, from the communications graph 104, nodes 112 that are linked to more than a threshold number of other nodes 112 in the communications graph 104. This is based on the notion that nodes having a very high degree (nodes representing users who communicate with an inordinately high number of other users) might actually represent call centers or other automated call services, as opposed to individual users acting in their individual capacity.

At 508, the computing device(s) may exclude, from the communications graph 104, nodes 112 that represent users 108 of the mobile telephony network who participated in less than a threshold number of communication sessions. Said another way, the nodes 112 that are kept in the communications graph 104 may be exclusively nodes 112 of users who made more than a threshold number (e.g., five) calls in either direction (i.e., as a caller or a callee). This filters out data that may not be very useful in the prediction algorithm.

At 510, the nodes 112 of the communications graph 104 may be matched with the banking records 102 based at least in part on encrypted phone numbers associated with both of the communications graph 104 and the banking records 102 to obtain a subset of nodes matched with banking records 102. After 510, an augmented communications graph 104 includes income information (e.g., estimated incomes) for a subset of the nodes 112(A) in the communications graph 104. This subset of nodes 112(A) (e.g., the black-colored nodes in FIG. 1) represent the subset of users 118 who are both bank customers 116 and users 108 of the mobile telephony network.

At 512, estimated incomes may be assigned to the subset of the nodes 112(A) of the communications graph 114 based at least in part on the set of matched records and from the banking records 102, which contain information associated with account balances of bank customers 116.

At 514, yet another outlier filtering step may be performed to exclude, from the communications graph 104, nodes 112 that are within the subset of the nodes and are associated with estimated incomes that are at least one of (i) less than a first threshold income or (ii) greater than a second threshold income. In an illustrative example using Mexican pesos, nodes representing users associated with a monthly income of less than $1000 may be excluded from the graph 104, and nodes representing users associated with a monthly income in the top 1% may be excluded from the graph 104. The remaining nodes represent users with a monthly income in the 99^{th} percentile, and who make at least $1000 per month, in the illustrative example.

The communications graph 104 resulting from the process 500 can be used with Bayesian prediction to classify users of a mobile telephony network as belonging to one of multiple income categories, as described herein.

### Example Results

The following disclosure is to demonstrate how the Bayesian approach to income inference, as described herein, outperforms other methods of predicting income of users. Starting with a classification scenario that uses two income categories (e.g., a high income category and a low income category) with a Beta distribution (See e.g., FIG. 2), the true positive rates (TPR) and false positive rates (FPR), TPR=TP/P and FPR=FP/N, were examined, where TP is the number of correctly predicted users with high income, P is the total number of users with high income, FP is the number of users incorrectly classified as having high income, and N is the total number of users with low income.

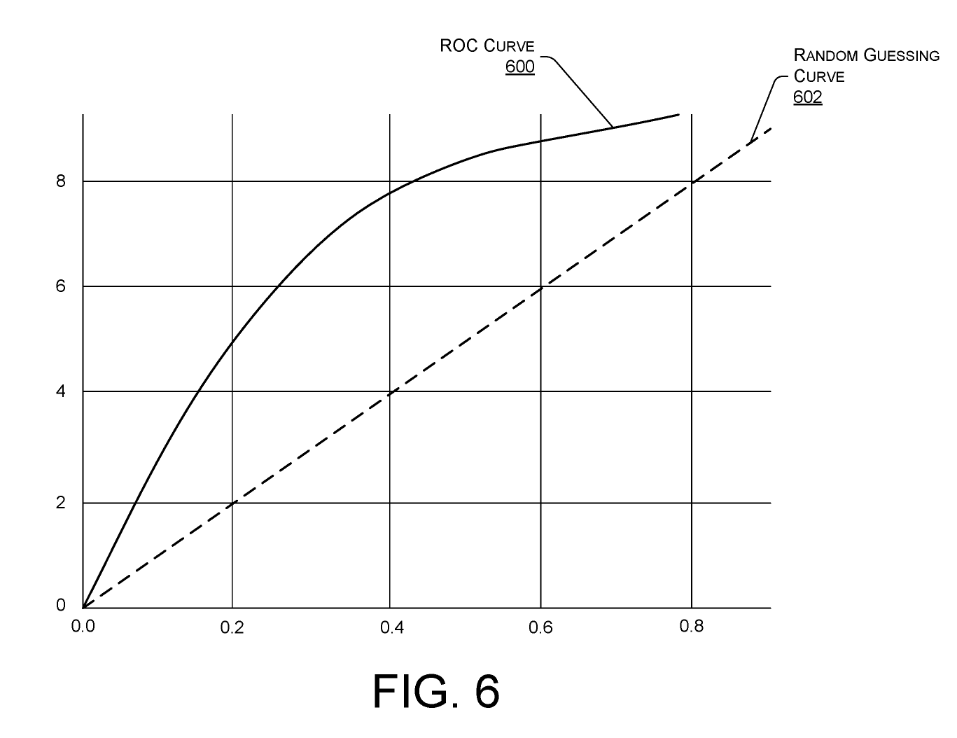

FIG. 6 illustrates the Receiver Operating Characteristic (ROC) curve 600, showing TPR and FPR for the set of possible values of the threshold, τ. It can be seen that the Bayesian approach to income inference, as described herein, outperforms random guessing (dashed straight line 602). The performance of the Bayesian approach to income inference can be summarized by calculating the Area Under the Curve (AUC) which, in FIG. 6 is AUC=0.74. Note that random guessing would give a value of AUC≃0.50. Alternatively, the performance of the Bayesian approach to income inference can be evaluated by computing its accuracy for a given threshold, τ. The best accuracy obtained is 0.71 for τ=0.4.

Comparison with Other Inference Methods:

Two other inference methods were applied to the same data and their accuracies were compared to the disclosed Bayesian model. The first other inference method is a Random selection method that randomly chooses the income category for each user. The second other inference method is a Majority voting method that decides whether a user is in the high or low income category depending on the category of the majority of its contacts. In case of a tie, the category is chosen randomly.

The accuracy of the Random selection method is as expected: 0.50. The accuracy for the Majority voting method turned out to be 0.66. When compared to the accuracy of 0.71 obtained using the disclosed Bayesian approach to income inference, it can be observed that the Bayesian approach outperforms the other inference methods, yielding higher accuracy in the estimation of users' income.

As noted above, when extending the analysis to the scenario where users are classified into more than two income categories, the results are similar. For example, the performance for the five different income categories 110 was observed as follows: Area Under Curve (AUC₁)=0.68, AUC₂=0.69, AUC₃=0.63, AUC₄=0.68, AUC₅=0.69. In all cases, the Bayesian prediction algorithm 106 performed better than the random case.

The Bayesian approach disclosed herein, can be used to infer income with improved accuracy, as compared to known alternative methods. This provides an estimation of socioeconomic attributes of users lacking banking history based on their communications network, which is useful for many downstream applications, such as targeting users with low credit risk for an acquisition campaign to gain efficiencies. It is to be appreciated that this Bayesian approach is not limited to the inference of socioeconomic attributes, and is equally applicable to any attribute that exhibits significant homophily in a network.

Machine Learning Approach:

Another approach that can be used to infer income based on communication patterns of users is a machine learning approach. In this machine learning approach, features can be extracted from mobile phone usage, as evidenced in CDRs, and supervised machine learning techniques can be used with sets of the features used as input to infer users' income. In such a machine learning approach, a communications graph can be constructed as a directed graph G= [symbol] V, E [symbol] , where the nodes V represent the users and the edges E represent the communication links between them. This graph may be created from CDRs and banking records, where V is the union of the origin and destination numbers on the intersection of (i) a set P of CDRs composed of voice calls, or a set S of CDRs composed of text messages and (ii) the set of numbers from an operator of the mobile telephony network, and where E contains one element for every pair of nodes in either direction, where the data is the accumulation of the number of calls, the total time of those calls, and the number of text messages.

A subset of the nodes, T⊆V contains the “Ground Truth” of the data, which indicates whether the user is part of the group of users with High Income or Low Income. This data is useful to train the predictors (machine learning model(s)), test them, and also to generate some features.

The set E contains the accumulated data of the edges between nodes. Each element e∈E may contain the following information, without limitation:
Origin of the calls and SMS, which is the outgoing endpoint of this edge in the graph
Destination of the calls and SMS, which is the incoming endpoint of this edge in the graph
Calls: the total number of calls from the origin to the destination
Time: the total time (in seconds) of all the calls from the origin to the destination
SMS: the total amount of messages from the origin to the destination

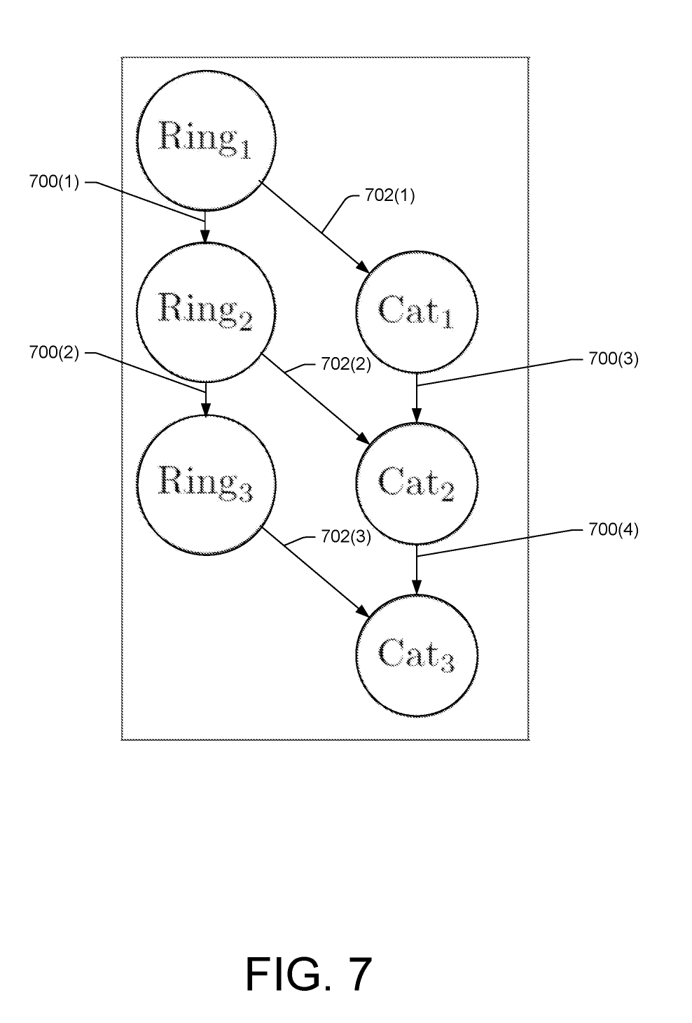

This data, along with the information in T, can be accumulated for each user in different ways in order to create features for each user which are then used in the prediction of the socioeconomic level. There are several ways of transforming data from the graph G= [symbol] V, E [symbol] into individual features for each user v∈V. The aggregations can be classified into levels named according to the transformation done to G, and they can be merged with levels containing less information as specified in FIG. 7. FIG. 7 shows the relationships between the Feature Extraction methods. Edges 700(1)-(4) represent an increase in Ego Network size, a process described in more detail below, while edges 702(1)-(3) represent adding label information, which is also described in more detail below.

TABLE 1

| Level | Features |
|---|---|
| Ring₁ | 8 |
| Ring₂ | 16 |
| Ring₃ | 24 |
| Cat₁ | 24 |
| Cat₂ | 48 |
| Cat₃ | 72 |

Table 1, above, shows the amount of total features/level.

User Data—Level Ring₁:

The first accumulated features include aggregating the three quantifiable features (Calls, Time, and SMS) for each node, separated on whether those features are incoming or outgoing. Additionally, two features can be added which correspond to the In-Degree and Out-Degree of each node. This can be seen as the sum of an imaginary feature on each link e∈E, Contacts, which is always exactly 1 when the link exists.

These features are defined for each node v∈V in Equations (1)-(4):

incontactsᵥ=|{e∈E|e_{d}=v}|

outcontactsᵥ=|{e∈E|eₒ=v}| (1)

incallsᵥ=Σₑ_{_{d}}₌ᵥ_{^{e∈E}} callsₑ outcallsᵥ=Σₑ_{ₒ}₌ᵥ_{^{e∈E}} callsₑ (2)

intimeᵥ=Σₑ_{_{d}}₌ᵥ_{^{e∈E}} timeₑ outtimeᵥ=Σₑ_{ₒ}₌ᵥ_{^{e∈E}} timeₑ (3)

insmsᵥ=Σₑ_{_{d}}₌ᵥ_{^{e∈E}} smsₑ outsmsᵥ=Σₑ_{ₒ}₌ᵥ_{^{e∈E}} smsₑ (4)

Higher Order User Data—Level Ring_{n>1}:

The features described above correspond to the information about calls and SMS from a user v∈V towards all its neighbors. However, this can be extended to nodes at a higher distance from v.

The Ego Network of the node v is defined as the graph including v and its neighbors. To get additional features about that node, the call and SMS information can be accumulated about the links with nodes which are not part of the Ego Network, but have a direct link with the border of the Ego Network. Additionally, the distance between two nodes can be defined using the intuitive definition presented in Equation (5), below, that is the minimum number of hops. The Ego Network of Order n of a particular node v is the subgraph composed of the node v, plus all the nodes which are at most at distance n of v, with the distance defined in Equation (5). The User Data of Order n can be defined for any natural number n as the accumulation of call and SMS information for the nodes which are part of the Ego Network of Order n and are not part of the Ego Network of Order n−1, which can be called the Ringₙ.

$$d ( a , b ) = \{ \begin{matrix}0 & if a = b \\ 1 + {min}_{v ∈ Neigh ( b )} d ( a , v ) & otherwise\end{matrix} \qquad ( 5 )$$

For reference purposes, the level Ring₁ can be assigned to the information of the regular User Data, while the user data from the Ego Network of Order n may be assigned Ringₙ for some n>1.

Categorical User Data—Level Catₙ:

Another approach to building features for the test is to combine the information contained in E, the list of edges, with the information of the Ground Truth T⊆V, which indicates whether a particular node represents a person of High Income or a person of Low Income. An approach similar to the User Data—Level Ring₁ approach can be used, but further discriminating each feature which corresponds to a node v∈V and an edge e∈E, where t∈T is the other endpoint of e, on whether t corresponds to a person with high or low income. The resulting new features are of the form represented by the set below:

$$\{ \begin{matrix}in \\ out\end{matrix} \} \times \{ \begin{matrix}calls \\ time \\ sms \\ contacts\end{matrix} \} \times \{ \begin{matrix}low \\ high\end{matrix} \}$$

It is noted that not all edges of G will be accumulated with these features. Indeed, the majority of users in the testing set T don't have a neighbor which also belongs to T, and for those nodes, every feature in this category ends up being 0.

For an experimental setting, the set of nodes F⊆T may be defined as the nodes in the Inner Graph (in contrast to the Full Graph, that contains all nodes in T), where F only contains nodes which have at least one neighbor with socioeconomic information. Experimental results show that the results obtained on the Inner Graph are better than the ones obtained on the Full Graph, since it contains more information.

Creating these features naively may occur in overfitting, if the model features were generated with data that is also used for training the supervised learning models. To avoid this overfitting, the set T may be partitioned into two disjoint sets, G and H, where G contains roughly 75% of the nodes of T and is used to calculate the features, while H contains the other 25% and is used to train the models. The Higher Order User Data—Level Ring_{n>1} approach can then be used to generate an Ego Network of Level n of a particular node v, and the adjacent nodes to that network can be accumulated by socioeconomic level before accumulating their data. The level of these features can be referred to as Catₙ.

The machine learning inference methodology is now explained. As mentioned, the nodes in T⊆V are separated into two disjoint subgroups, G and H, so that G∪H=T, G∩H=∅, |G|=0.75·|T|, and |H|=0.25·|T|. Furthermore, the subset Hᵢₙₙₑᵣ⊆H can be defined so that a node h∈Hᵢₙₙₑᵣ if and only if h∈H and there is an edge [symbol] h, x [symbol] ∈E or [symbol] x, h [symbol] ∈E such that x∈H. This later definition helps with performing inferences on features using the Categorical User Data dataset.

The inferences based on features aggregated by node may be performed using Logistic Regression classifiers, Random Forest classifiers, or any similar machine learning model. Since Logistic Regression and Random Forest classifiers tend to have different variance in the results, noise from different sources doesn't tend to affect either predictor. The features described above can be used as input to the classifier, where each level is merged with all of the previous levels of the data on G. This helps ensure that useful information is not lost when adding new data, and ideally every prediction should be better or equal than the ones in the previous levels. Table 1, above, shows the amount of features in each level after merging.

The classifiers are trained using those features and the labels in H doing a Grid Search on different hyperparameters of the predictors with 5-fold cross-validation to prevent cases of overfitting. The F₄ score of each prediction can be measured. In addition, the node-based methods are compared against the Random Selection method, the Majority Voting method, and the Bayesian approach disclosed herein to infer income of users. As expected, in Random Selection, the probability of success is 50/50. In Majority Voting, the category of each user v∈V depends on whether the majority of its contacts are of high or low income categories. If the user has the exact same number of contacts of each category, the income category for that user is chosen randomly.

Observations of test results indicate that use of a Random Forests classifier tends to perform better than the Logistic Regression classifier. Increasing the breadth of the Ego Network by one level, from Ring₁ to Ring₂ improves the performance when using Random Forest learning, but it does not improve by going one level further to Ring₃ in the case of the Inner Graph, despite the fact that this data is a strict superset of the previous Ring₂. Adding categorical information improves the prediction when using either method, particularly on Random Forest, and adding neighboring data of the Ego Network of distance 2 also results in a better predictor. However, this doesn't happen when raising further the maximum distance with the ego network in the case of the Inner Graph.

In conclusion, within the machine learning methods presented, the best in terms of AUC is predicting the income category using a Random Forest with the data from the Ego Network of distance 2 (Cat₂) in the case of the Inner Graph. In the Full Graph, using Cat₃ data results in slightly better results, however, the difference with Cat₂ is very small.

Finally, in the Inner Graph the best method observed is the Bayesian approach disclosed herein, which uses the amount of High Income and Low Income users in the Ego Network, but makes a “smarter” prediction than the machine learning methods LR and RF using the models Cat₁, Cat₂, and Cat₃, which also contain this data. Thus, the machine learning methods, which use many features (despite these features being informative) have not been observed to be better at predicting the socioeconomic level of a user than the Bayesian approach described herein, which uses two features of the communication graph. That said, the machine learning approach to income inference may be used as an alternative to the Bayesian approach for predicting income of users.

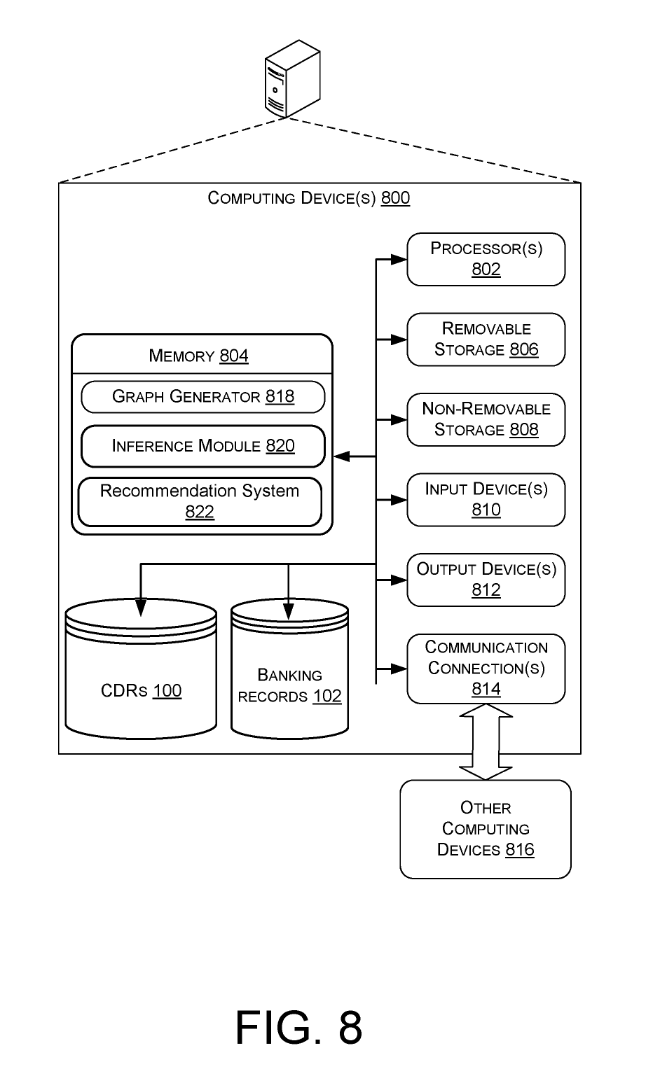

FIG. 8 is a block diagram of an example architecture of a computing device 800 configured to implement the techniques described herein. As shown, the computing device 800 may include one or more processors 802 and one or more forms of computer-readable memory 804. The computing device 800 may also include additional storage devices. Such additional storage may include removable storage 806 and/or non-removable storage 808.

In various embodiments, the computer-readable memory 804 generally includes both volatile memory and non-volatile memory (e.g., random access memory (RAM), read-only memory (ROM), erasable programmable read-only memory (EEPROM), Flash Memory, miniature hard drive, memory card, optical storage, magnetic cassettes, magnetic tape, magnetic disk storage or other magnetic storage devices, or any other medium). The computer-readable memory 804 may also be described as computer storage media and may include volatile and nonvolatile, removable and non-removable media implemented in any method or technology for storage of information, such as computer readable instructions, data structures, program modules, or other data. Computer-readable memory 804, as well as the removable storage 806 and non-removable storage 808, are all examples of computer-readable storage media. Computer-readable storage media include, but are not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the computing device 800. Any such computer-readable storage media may be part of the computing device 800.

The computing device 800 may further include input devices 810, including, without limitation, a touch screen (e.g., touch, or proximity-based) display, physical buttons (e.g., keyboard or keypad), a microphone, pointing devices (e.g., mouse, pen, stylus, etc.), or any other suitable input devices 810 coupled communicatively to the processor(s) 802 and the computer-readable memory 804. The computing device 800 may further include output devices 812, including, without limitation, a display, one or more LED indicators, speakers, a printer, or any other suitable output device coupled communicatively to the processor(s) 802 and the computer-readable memory 804.

The computing device 800 may further include communications connection(s) 814 that allow the computing device 800 to communicate with other computing devices 816 such as via a network(s). The communications connection(s) 814 may facilitate transmitting and receiving wireless and/or wired signals over any suitable communications/data technology, standard, or protocol, as described above, such as using a packet data network protocol.

In some embodiments, the computer-readable memory 804 may include various modules, programs, objects, components, data structures, routines, and the like that perform particular functions according to various embodiments. In some embodiments, the computer-readable memory 804 includes a graph generator 818 configured to generate the communications graph 104 of FIG. 1 by accessing CDRs 100 and banking records 102, which may be maintained in any suitable data structure, such as a database or any similar data repository, store, or the like, which may be accessed by the one or more processors 802.

The computer-readable memory 804 may further include an inference module 820 configured to classify nodes (i.e., users) of the communications graph 104 as belonging to one of multiple income categories 110, as described herein. The inference module 820 may employ the Bayesian approach to income inference, as described herein.

The computer-readable memory 804 may further include a recommendation system 822 configured to process inferred user income data generated by the inference module 820, and to output a targeted set of users associated with contact channels, which can be used to optimize an acquisition campaign.

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

We claim:

1. A computer-implemented method comprising:
generating a communications graph based at least in part on call detail records (CDRs) that contain information associated with communication sessions established over a mobile telephony network, the communications graph including:
nodes corresponding to users of the mobile telephony network; and
links connecting pairs of the nodes based on the communication sessions;
assigning estimated incomes to a subset of the nodes of the communications graph based at least in part on banking records that contain information associated with account balances of bank customers, the subset of the nodes representing a subset of the users of the mobile telephony network who are also the bank customers; and
for a selected node of the communications graph that is not within the subset of the nodes, and which is connected by a link to at least one node within the subset of the nodes:
computing a number of outgoing communication sessions from the selected node to nodes of the communications graph associated with estimated incomes that are within a particular income category among multiple income categories;
defining a prior probability distribution of a Bayesian inference, the prior probability distribution usable to determine a probability of belonging to the particular income category, wherein the number of outgoing communication sessions is used for a parameter of the prior probability distribution;
computing a value for a lowest fifth percentile of the prior probability distribution; and
classifying the selected node as belonging to the particular income category based at least in part on the value for the lowest fifth percentile.

2. The computer-implemented method of claim 1, wherein:
the prior probability distribution comprises a Beta distribution;
the multiple income categories comprise a high income category and a low income category; and
the classifying the selected node as belonging to the particular income category comprises:
determining that the value for the lowest fifth percentile is greater than a threshold value; and
classifying the selected node as belonging to the particular income category based at least in part on the value being greater than the threshold value.

3. The computer-implemented method of claim 1, wherein:
the prior probability distribution comprises a Dirichlet distribution;
the multiple income categories comprise more than two income categories; and
the classifying the selected node as belonging to the particular income category comprises:
computing marginal probability functions across the multiple income categories to obtain a Beta distribution for each income category of the multiple income categories;
computing the value for the lowest fifth percentile of each Beta distribution to obtain multiple values for the lowest fifth percentile;
determining a highest value among the multiple values for the lowest fifth percentile; and
classifying the selected node as belonging to the particular income category based at least in part on the highest value being associated with the particular income category.

4. The computer-implemented method of claim 1, further comprising, for additional nodes of the communications graph that are not within the subset of the nodes, and which are each connected by a link to at least one node within the subset of the nodes:
classifying the additional nodes as belonging to one of the multiple income categories using the prior probability distribution to generate inferred user income data;
providing the inferred user income data as input to a recommendation system;
receiving, as output from the recommendation system, a targeted set of users associated with respective contact channels; and
contacting, via the respective contact channels, the targeted set of users for an acquisition campaign.

5. The computer-implemented method of claim 1, further comprising excluding, from the communications graph, nodes that:
are linked to more than a threshold number of other nodes in the communications graph;
represent users of the mobile telephony network who participated in less than a threshold number of communication sessions; or
are within the subset of the nodes and are associated with estimated incomes that are at least one of (i) less than a first threshold income or (ii) greater than a second threshold income.

6. A computer-implemented method comprising:
generating a communications graph that includes nodes and links, wherein a subset of the nodes represent users of a mobile telephony network whose income is estimated based on available banking records, and wherein the links connect pairs of the nodes based on communication sessions between the users of the mobile telephony network, as indicated in available call data records (CDRs); and
for a selected node of the communications graph that is not within the subset of the nodes, and which is connected by a link to at least one node within the subset of the nodes:
computing a number of outgoing communication sessions from the selected node to nodes of the communications graph that are associated with estimated incomes within a particular income category among multiple income categories;
defining a prior probability distribution of a Bayesian inference, the prior probability distribution usable to determine a probability of belonging to the particular income category, wherein the number of outgoing communication sessions is used for a parameter of the prior probability distribution;
computing a value for a lowest N^{th} percentile of the prior probability distribution; and
classifying the selected node as belonging to the particular income category based at least in part on the value for the lowest N^{th} percentile.

7. The computer-implemented method of claim 6, wherein:
the prior probability distribution comprises a Beta distribution;
the multiple income categories comprise a high income category and a low income category; and
the classifying the selected node as belonging to the particular income category comprises:
determining that the value for the lowest N^{th} percentile is greater than a threshold value; and
classifying the selected node as belonging to the particular income category based at least in part on the value being greater than the threshold value.

8. The computer-implemented method of claim 6, wherein:
the prior probability distribution comprises a Dirichlet distribution;
the multiple income categories comprise more than two income categories; and
the classifying the selected node as belonging to the particular income category comprises:
computing marginal probability functions across the multiple income categories to obtain a Beta distribution for each income category of the multiple income categories;
computing the value for the lowest N^{th} percentile of each Beta distribution to obtain multiple values for the lowest N^{th} percentile;
determining a highest value among the multiple values for the lowest N^{th} percentile; and
classifying the selected node as belonging to the particular income category based at least in part on the highest value being associated with the particular income category.

9. The computer-implemented method of claim 6, wherein the lowest N^{th} percentile comprises the lowest fifth percentile.

10. The computer-implemented method of claim 6, further comprising, for additional nodes of the communications graph that are not within the subset of the nodes, and which are each connected by a link to at least one node within the subset of the nodes:
classifying the additional nodes as belonging to one of the multiple income categories using the prior probability distribution to generate inferred user income data;
providing the inferred user income data as input to a recommendation system;
receiving, as output from the recommendation system, a targeted set of users associated with respective contact channels; and
contacting, via the respective contact channels, the targeted set of users for an acquisition campaign.

11. The computer-implemented method of claim 6, further comprising:
matching the nodes of the communications graph with the banking records based at least in part on encrypted phone numbers associated with the communications graph and the banking records to obtain the subset of the nodes matched with the banking records; and
assigning the estimated incomes to the subset of the nodes of the communications graph that are matched with the banking records.

12. The computer-implemented method of claim 6, further comprising, prior to the generating of the communications graph, filtering the CDRs to exclude a subset of the CDRs that correspond to calls that lasted less than a threshold amount of time.

13. The computer-implemented method of claim 6, further comprising excluding, from the communications graph, nodes that:
are linked to more than a threshold number of other nodes in the communications graph;
represent users of the mobile telephony network who participated in less than a threshold number of communication sessions; or
are within the subset of the nodes and are associated with estimated incomes that are at least one of (i) less than a first threshold income or (ii) greater than a second threshold income.

14. A system comprising:
one or more processors; and
memory storing computer-executable instructions that, when executed by the one or more processors, cause the system to:
generate a communications graph that includes a subset of nodes representing users of a mobile telephony network whose income is estimated based on available banking records, wherein links connecting pairs of the nodes are based on communication sessions between the users of the mobile telephony network, as indicated in available call data records (CDRs); and
for a selected node of the communications graph that is not within the subset of the nodes, and which is connected by a link to at least one node within the subset of the nodes:
compute a number of outgoing communication sessions from the selected node to nodes of the communications graph that are associated with estimated incomes within a particular income category among multiple income categories;
define a prior probability distribution of a Bayesian inference, the prior probability distribution usable to determine a probability of belonging to the particular income category, wherein the number of outgoing communication sessions is used for a parameter of the prior probability distribution;
compute a value for a lowest N^{th} percentile of the prior probability distribution; and
classify the selected node as belonging to the particular income category based at least in part on the value for the lowest N^{th} percentile.

15. The system of claim 14, wherein:
the prior probability distribution comprises a Beta distribution;
the multiple income categories comprise a high income category and a low income category; and
classifying the selected node as belonging to the particular income category comprises:
determining that the value for the lowest N^{th} percentile is greater than a threshold value; and
classifying the selected node as belonging to the particular income category based at least in part on the value being greater than the threshold value.

16. The system of claim 14, wherein:
the prior probability distribution comprises a Dirichlet distribution;
the multiple income categories comprise more than two income categories; and
classifying the selected node as belonging to the particular income category comprises:
computing marginal probability functions across the multiple income categories to obtain a Beta distribution for each income category of the multiple income categories;
computing the value for the lowest N^{th} percentile of each Beta distribution to obtain multiple values for the lowest N^{th} percentile;
determining a highest value among the multiple values for the lowest N^{th} percentile; and
classifying the selected node as belonging to the particular income category based at least in part on the highest value being associated with the particular income category.

17. The system of claim 14, wherein the computer-executable instructions, when executed by the one or more processors, further cause the system to, for additional nodes of the communications graph that are not within the subset of the nodes, and which are each connected by a link to at least one node within the subset of the nodes:
classify the additional nodes as belonging to one of the multiple income categories using the prior probability distribution to generate inferred user income data;
provide the inferred user income data as input to a recommendation system;
receive, as output from the recommendation system, a targeted set of users associated with respective contact channels; and
contact, via the respective contact channels, the targeted set of users for an acquisition campaign.

18. The system of claim 14, wherein the lowest N^{th} percentile comprises the lowest fifth percentile.

19. The system of claim 14, wherein the computer-executable instructions, when executed by the one or more processors, further cause the system to exclude, from the communications graph, nodes that:
are linked to more than a threshold number of other nodes in the communications graph;
represent users of the mobile telephony network who participated in less than a threshold number of communication sessions; or
are within the subset of the nodes and are associated with estimated incomes that are at least one of (i) less than a first threshold income or (ii) greater than a second threshold income.

20. The system of claim 14, wherein the computer-executable instructions, when executed by the one or more processors, further cause the system to, prior to generating the communications graph, filter the CDRs to exclude a subset of the CDRs that correspond to calls that lasted less than a threshold amount of time.
